(19) United States
(12) Patent Application Publication
(10) Pub. No.: US 2012/0169294 A1
(43) Pub. Date: Jul. 5, 2012

(54) CIRCUIT AND METHOD FOR POWER PATH MANAGEMENT

(75) Inventors: Hsuan-Kai WANG, New Taipei City (TW); Nien-Hui KUNG, Miaoli County (TW); Chia-Hsiang LIN, Taipei City (TW)

(73) Assignee: Richtek Technology Corp., Chupei City (TW)

(21) Appl. No.: 13/341,672

(22) Filed: Dec. 30, 2011

(30) Foreign Application Priority Data
Jan. 4, 2011 (TW) 100100203

(51) Int. Cl. H02J 7/00

(52) U.S. Cl. 320/137

(57) ABSTRACT

A circuit and method for power path management track the input voltage at a power input terminal to generate a reference voltage, and generate a control signal for controlling a charger control circuit coupled between a power output terminal and a charger output terminal according to the difference between the voltage at the power output terminal and the reference voltage.

### FIELD OF THE INVENTION

The present invention is related generally to power management and, more particularly to a circuit and method for power path management.

### BACKGROUND OF THE INVENTION

As shown in FIG. 1, a conventional dual power source arrangement includes two current paths for connecting a power supply Vin at a power input terminal IN and a battery 10 at a charger output terminal BAT to a load system 12 at a power output terminal OUT, respectively, in a parallel manner, a transistor Q1 coupled between the power input terminal IN and the power output terminal OUT as a low-dropout (LDO) linear regulator to control the input current Iin from the power input terminal IN supplied by the power supply Vin, a transistor Q2 coupled between the power output terminal OUT and the charger output terminal BAT as a charger control circuit to control the charger current Ibat flowing to the charger output terminal BAT for charging the battery 10, and a circuit for power path management 14 to control the transistor Q2 by comparing the system voltage Vsys supplied to the load system 12 with a reference voltage VAPPM by an amplifier 16 to generate a control signal for a driver 18 to provide the gate voltage of the transistor Q2, i.e., control the charging to the battery 10. In normal operation, the system voltage Vsys is approximately equal to the input voltage Vin and is significantly higher than the reference voltage VAPPM, and thus the amplifier 16 will remain the transistor Q2 on for allowing the charger current Ibat to charge the battery 10. When loading becomes heavier to the extent that the sum of the system current Isys drawn by the load system 12 and the charger current Ibat is larger than the upper limit of the input current Iin, the system voltage Vsys will decrease and become closer to the reference voltage VAPPM, and in response to the reduced difference between the system voltage Vsys and the reference voltage VAPPM, the amplifier 16 will adjust the control signal for the driver 18, so as to control the transistor Q2 to decrease the charger current Ibat, thereby allowing the system current Isys larger. However, once the input voltage Vin decreases to be lower than the reference voltage VAPPM, the circuit for power path management 14 will turn off the charger current Ibat, so that the battery 10 will be no longer charged. Therefore, the difference between the input voltage Vin and the reference voltage VAPPM will determine if the battery 10 is possible to be charged.

FIG. 2 and FIG. 3 depict two conventional methods for controlling the reference voltage VAPPM. In the approach shown in FIG. 2, the reference voltage VAPPM is fixed, and the input voltage Vin must be higher than the reference voltage VAPPM to confirm that the battery 10 will be charged. Once the input voltage Vin becomes lower than the reference voltage VAPPM, the charger current Ibat will be zero. The method shown in FIG. 3 has the reference voltage VAPPM tracking the battery voltage Vbat with a fixed offset voltage Vos higher than the battery voltage Vbat, and thus when the input voltage Vin begins decreasing, the system voltage Vsys will not become lower than the reference voltage VAPPM sooner, so that the battery 10 can still be charged. However, in consideration of energy, (Vin-VAPPM)×Iin represents the wasted power. The reference voltage VAPPM of FIG. 3 varies with the battery voltage Vbat, so the wasted power (Vin-VAPPM)×Iin is equal to (Vin-Vbat)×Iin, which is greater than that of using a fixed reference voltage VAPPM as shown in FIG. 2. The wasted energy will become heat and thus cause the temperature of the system increasing, resulting in poor thermal performance.

### SUMMARY OF THE INVENTION

An objective of the present invention is to provide a circuit for power path management.

Another objective of the present invention is to provide a method for power path management.

According to the present invention, a circuit for power path management includes a reference generator to generate a reference voltage according to the voltage at a power input terminal, and an amplifier to generate a control signal according to the difference between the voltage at a power output terminal and the reference voltage, to control a charger control circuit coupled between the power output terminal and a charger output terminal.

According to the present invention, a method for power path management includes generating a reference voltage according to the voltage at a power input terminal, and generating a control signal according to the voltage at a power output terminal and the reference voltage, to control a charger current for charging a battery.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a conventional dual power source arrangement;

FIG. 2 depicts a conventional method for power path management;

FIG. 3 depicts another conventional method for power path management;

FIG. 4 is a circuit diagram of an embodiment according to the present invention;

FIG. 5 is a circuit diagram of a first embodiment for the reference generator shown in FIG. 4;

FIG. 6 is a diagram showing the reference voltage provided by the circuit of FIG. 5 to the input voltage provided by a power supply;

FIG. 7 is a circuit diagram of a second embodiment for the reference generator shown in FIG. 4;

FIG. 8 is a diagram showing the reference voltage provided by the circuit of FIG. 7 to the input voltage provided by a power supply;

FIG. 9 is a circuit diagram of a third embodiment for the reference generator shown in FIG. 4;

FIG. 10 is a diagram showing the reference voltage provided by the circuit of FIG. 9 to the input voltage provided by a power supply;

FIG. 11 is a circuit diagram of a fourth embodiment for the reference generator shown in FIG. 4; and

FIG. 12 is a diagram showing the reference voltage provided by the circuit of FIG. 11 to the input voltage provided by a power supply.

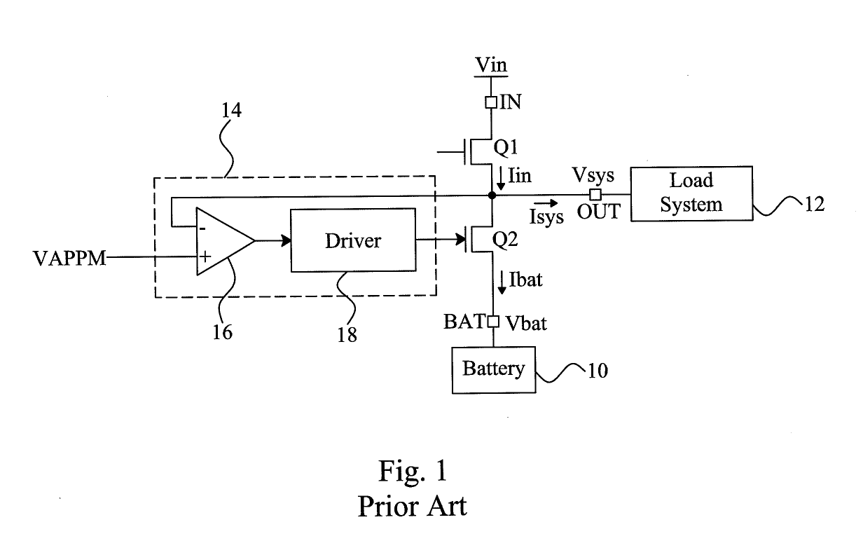

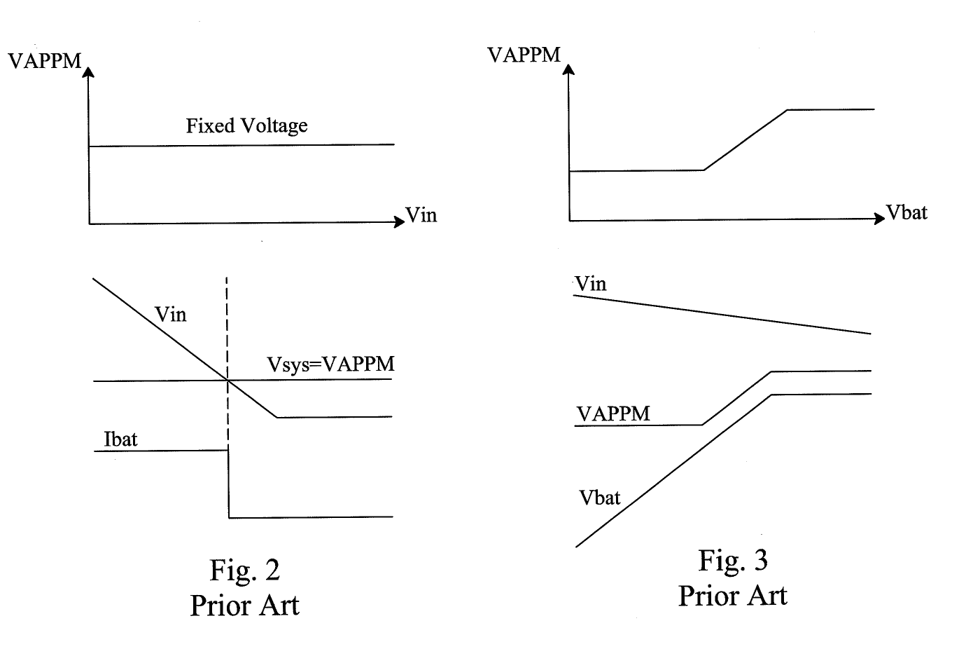

### DETAILED DESCRIPTION OF THE INVENTION

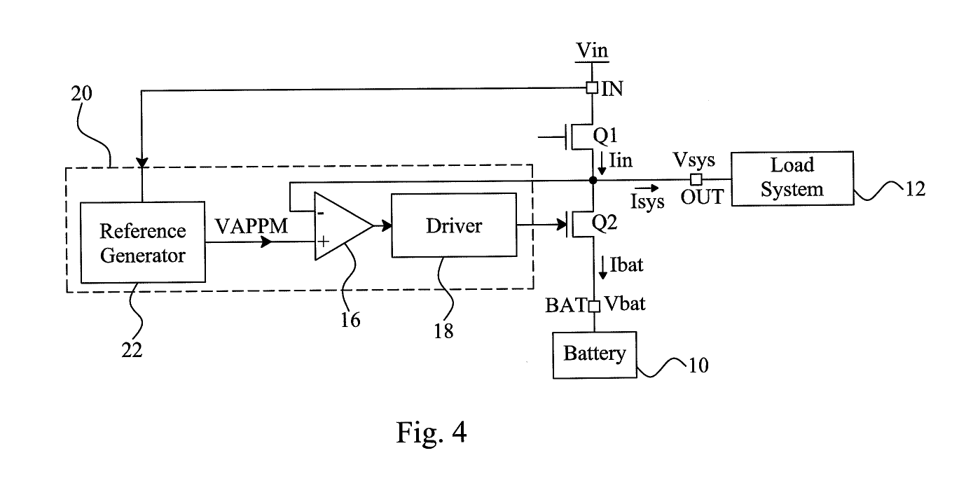

FIG. 4 is a circuit diagram of an embodiment according to the present invention, in which a circuit for power path management 20 includes a reference generator 22 coupled to an input terminal of an amplifier 16 and the power input terminal IN that is coupled with a power supply Vin, and the reference generator 22 tracks the input voltage Vin to generate a reference voltage VAPPM for the amplifier 16 to compare with the system voltage Vsys supplied to the load system 12 at the power output terminal OUT, to generate a control signal for a driver 18 to provide the gate voltage of the transistor Q2 coupled between the power output terminal OUT and the charger output terminal BAT coupled with a battery 10, so that when the input voltage Vin or the system voltage Vsys decreases due to heavy loading, the reference voltage VAPPM will decrease accordingly, and thus the system voltage Vsys will remain higher than the reference voltage VAPPM, resulting in the control signal generated by the amplifier 16 being able to keep the transistor Q2 on for allowing the battery 10 being charged.

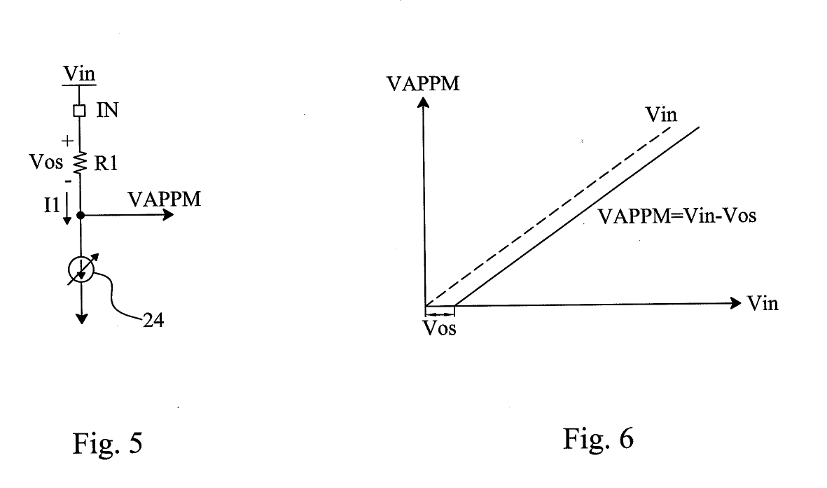

FIG. 5 is a circuit diagram of a first embodiment for the reference generator 22 shown in FIG. 4, and FIG. 6 is a diagram showing the reference voltage VAPPM provided by the circuit of FIG. 5 to the input voltage Vin at the power input terminal IN. In this embodiment, the reference generator 22 includes a resistor R1 and an adjustable current source 24 connected in series between the power input terminal IN and the ground terminal, and a current I1 flows through the resistor R1 to generate a voltage drop Vos across the resistor R1, so that the reference voltage VAPPM obtained from the reference output terminal VAPPM will be lower than the input voltage Vin by the offset voltage Vos, which will vary with the current I1 provided by the adjustable current source 16. In consideration of energy, in this embodiment, VAPPM=Vin−Vos, and thus the wasted power (Vin-VAPPM)x Tin remains at Vos×Iin, thereby ensuring good power efficiency and thermal performance.

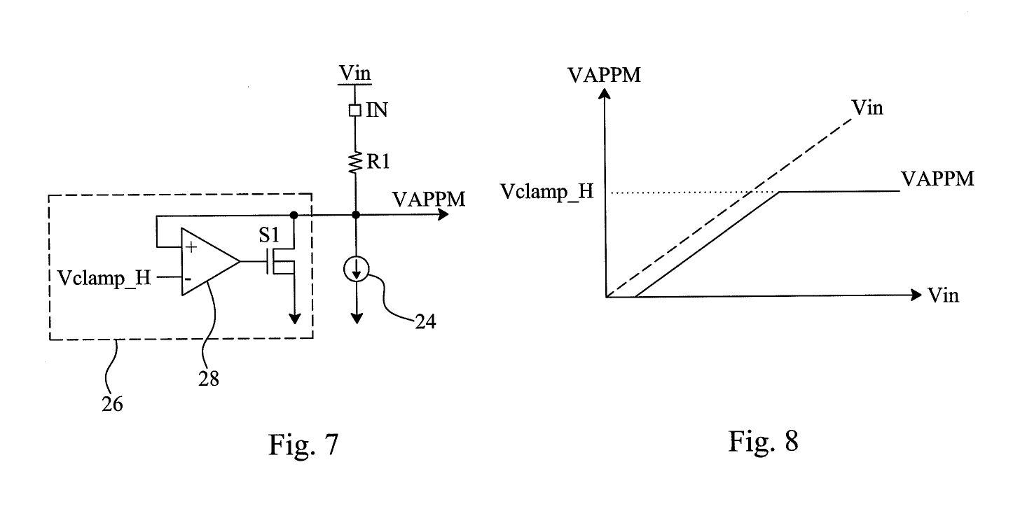

FIG. 7 is a circuit diagram of a second embodiment for the reference generator 22 shown in FIG. 4, and FIG. 8 is a diagram showing the reference voltage VAPPM provided by the circuit of FIG. 7 to the input voltage Vin at the power input terminal IN. As compared with the circuit of FIG. 5, this embodiment further includes a high-voltage limiter circuit 26 coupled to the reference output terminal VAPPM, to limit the maximum of the reference voltage VAPPM. The high-voltage limiter circuit 26 includes a MOSFET S1 coupled between the reference output terminal VAPPM and the ground terminal, and an operational amplifier 28 to control the MOSFET S1 according to the difference between the reference voltage VAPPM and a preset maximum voltage Vclamp_H. When the reference voltage VAPPM increases to the maximum voltage Vclamp_H, the operational amplifier 28 will control the MOSFET S1 to keep the reference voltage VAPPM at the maximum voltage Vclamp_H.

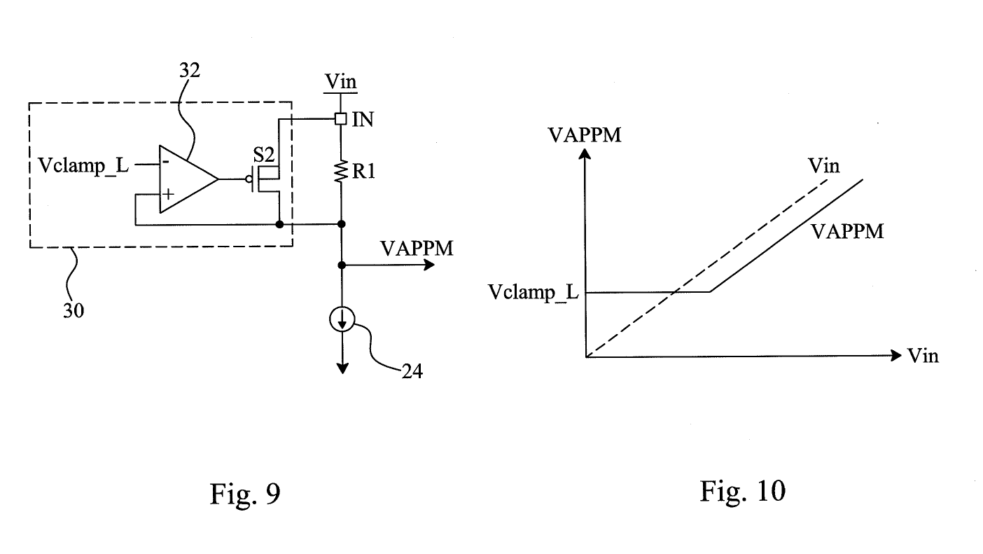

FIG. 9 is a circuit diagram of a third embodiment for the reference generator 22 shown in FIG. 4, and FIG. 10 is a diagram showing the reference voltage VAPPM provided by the circuit of FIG. 9 to the input voltage Vin at the power input terminal IN. As compared with the circuit of FIG. 5, this embodiment further includes a low-voltage limiter circuit 30 coupled to the reference output terminal VAPPM, to limit the minimum of the reference voltage VAPPM. The low-voltage limiter circuit 30 includes a MOSFET S2 coupled between the power input terminal IN and the reference output terminal VAPPM, and an operational amplifier 32 to control the MOSFET S2 according to the difference between the reference voltage VAPPM and a preset minimum voltage Vclamp_H. When the reference voltage VAPPM decreases to the minimum voltage Vclamp_L, the operational amplifier 32 will control the MOSFET S2 to keep the reference voltage VAPPM at the minimum voltage Vclamp_L.

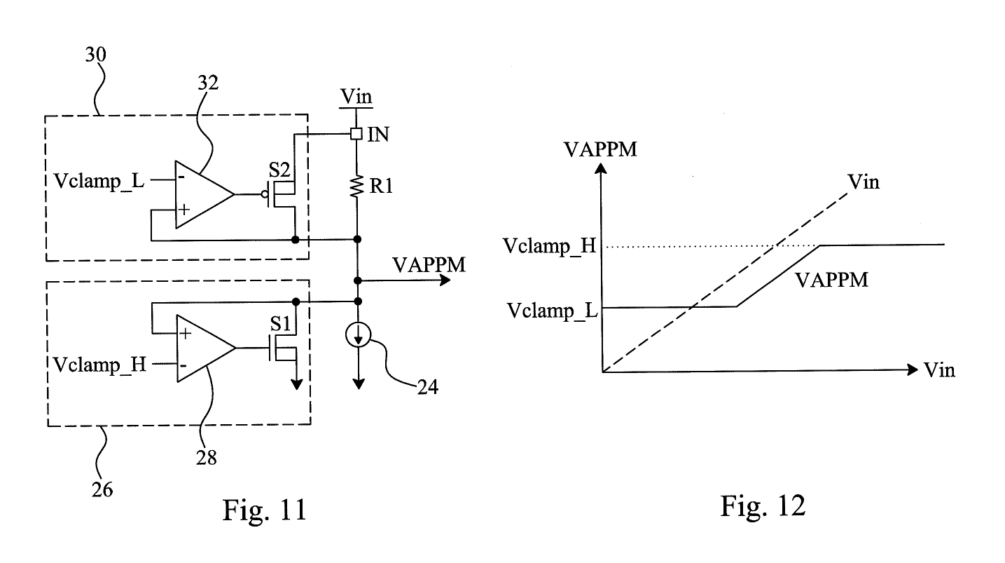

FIG. 11 is a circuit diagram of a fourth embodiment for the reference generator 22 shown in FIG. 4, and FIG. 12 is a diagram showing the reference voltage VAPPM provided by the circuit of FIG. 11 to the input voltage Vin at the power input terminal IN. This embodiment is a combination of the circuits of FIG. 7 and FIG. 9, and thus the reference voltage VAPPM will track the input voltage Vin, but is limited between the maximum voltage Vclamp_H and the minimum voltage Vclamp_L.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A circuit for power path management, comprising:
a reference generator coupled to a power input terminal having an input voltage, tracking the input voltage to generate a reference voltage; and
an amplifier coupled to a power output terminal and the reference generator, generating a control signal according to a difference between a voltage at the power output terminal and the reference voltage, to control a charger control circuit coupled between the power output terminal and a charger output terminal.

2. The circuit for power path management of claim 1, wherein the reference generator comprises:
a resistor coupled between the power input terminal and a reference output terminal providing the reference voltage; and
a current source serially connected to the resistor through the reference output terminal, providing a current flowing through the resistor to generate the reference voltage tracking the input voltage with an offset voltage.

3. The circuit for power path management of claim 1, wherein the reference generator comprises:
a resistor coupled between the power input terminal and a reference output terminal providing the reference voltage;
a current source serially connected to the resistor through the reference output terminal, providing a current flowing through the resistor to generate the reference voltage tracking the input voltage with an offset voltage; and
a high-voltage limiter circuit coupled to the reference output terminal, preventing the reference voltage from being higher than a maximum voltage.

4. The circuit for power path management of claim 3, wherein the high-voltage limiter circuit comprises:
a MOSFET coupled between the reference output terminal and a ground terminal; and
an operational amplifier having two input terminals receiving the reference voltage and the maximum voltage, respectively, and an output terminal coupled to a control terminal of the MOSFET.

5. The circuit for power path management of claim 1, wherein the reference generator comprises:
a resistor coupled between the power input terminal and a reference output terminal providing the reference voltage;
a current source serially connected to the resistor through the reference output terminal, providing a current flowing through the resistor to generate the reference voltage tracking the input voltage with an offset voltage; and
a low-voltage limiter circuit coupled to the reference output terminal, preventing the reference voltage from being lower than a minimum voltage.

6. The circuit for power path management of claim 5, wherein the low-voltage limiter circuit comprises:
a MOSFET coupled between the power input terminal and the reference output terminal; and
an operational amplifier having two input terminals receiving the reference voltage and the minimum voltage, respectively, and an output terminal coupled to a control terminal of the MOSFET.

7. A method for power path management, comprising steps of:
A.) tracking an input voltage at a power input terminal to generate a reference voltage; and
B.) generating a control signal according to a difference between a voltage at a power output terminal and the reference voltage, to control a charger control circuit coupled between the power output terminal and a charger output terminal.

8. The method for power path management of claim 7, wherein the step B comprises a step of generating the reference voltage lower than the input voltage by an offset voltage.

9. The method for power path management of claim 8, further comprising a step of preventing the reference voltage from being higher than a maximum voltage.

10. The method for power path management of claim 8, further comprising a step of preventing the reference voltage from being lower than a minimum voltage.
